(19) United States
(12) Patent Application Publication
(10) Pub. No.: US 2005/0083413 A1
(43) Pub. Date: Apr. 21, 2005

(54) Method, system, apparatus, and machine-readable medium for use in connection with a server that uses images or audio for initiating remote function calls

(75) Inventors: Jeffrey T. Reed, Sammamish, WA (US); James E. Torelli, Bothell, WA (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Logicalis, Bellevue, WA (US)

(21) Appl. No.: 10/783,773

(22) Filed: Feb. 20, 2004

Related U.S. Application Data
(60) Provisional application No. 60/512,932, filed on Oct. 20, 2003.

(51) Int. Cl. H04N 5/232

(52) U.S. Cl. 348/211.99

(57) ABSTRACT

Images, audio, biometric information, and other data is captured by a user device. The captured data is sent to a server that pre-processes and then decodes the captured data to identify its contents. Once identified, the captured data is associated with a function string that specifies a function and parameters that correspond to the captured data. The function is called and executed to provide information back to the user device that is relevant to the captured data, or to initiate other operations. The relevant information to return to the user device can include product information, translations, auction data, electronic device settings, audio, and others. Operations that may be initiated include software registration, people searches, or user authentication to allow access to restricted services.

### CROSS-REFERENCE TO RELATED APPLICATION

This application claims the benefit under 35 U.S.C. 119(e) of U.S. Provisional Patent Application No. 60/512,932, entitled “METHOD, SYSTEM, APPARATUS, AND MACHINE-READABLE MEDIUM FOR USE IN CONNECTION WITH A SYMBOLS ENTERPRISE SERVER,” filed Oct. 20, 2003, which is incorporated herein by reference in its entirety.

### TECHNICAL FIELD

The present disclosure relates generally to image capturing and processing technology and data communication over a network, and more particularly but not exclusively, relates to the capture and communication of 1-dimensional (1D) or 2-dimensional (2D) images or audio, for instance, via a user device, use of remote function calls at a server to obtain information relevant to the images/audio, and the returning of the obtained information to the user device and/or the authenticating of the user device.

### BACKGROUND INFORMATION

The Internet is one of the widespread and popular tools for obtaining information about virtually any subject. For example, Internet users (sometimes referred to as web “surfers”) can obtain information about products they wish to purchase (such as prices, product descriptions, manufacturer information, and the like), statistics pertaining to favorite sports teams or players, informational content about tourist destinations, and so on. Indeed, it is becoming almost ubiquitous for persons to surf the Internet for information instead of searching through traditional printed media.

However, despite its widespread use and wealth of information, the Internet can often still be a generally clumsy and inconvenient tool. For example, if a shopper in a store notices a product that is on sale, the shopper is typically limited to only being able to peruse the limited amount of on-site printed literature that accompanies that product. In many cases, such on-site printed literature provides insufficient information, and the shopper is not allowed to open the packaging of the product while in the store so as to review more-detailed product literature that may or may not be contained inside. Instead, to obtain more detailed information about that particular product's warranty, manufacturer, feature descriptions, related accessories, product reviews, and so forth, the user generally has to return home, connect to the Internet, and then use some type of Internet search engine to locate the relevant information.

This example scenario highlights some glaring disadvantages. First, the shopper needs to remember the product name and manufacturer before leaving the store, so as to be able to properly formulate a search query for the Internet search engine when the shopper arrives home. This can prove problematic in situations where the shopper may have a poor memory and/or where the original interest in the product begins to fade after the shopper leaves the store (especially if several days pass by before the shopper gets online on the Internet). Therefore, a significant sales opportunity may have been lost by the manufacturer and store, as well as an opportunity for the shopper to buy a needed product.

Second, this example scenario assumes that the shopper is computer savvy and/or has the technical resources at home. This is not always the case. That is, while many individuals have a basic working understanding of the Internet, many individuals can use some improvement in honing their online searching skills and often fail to locate the most relevant and useful information with their search queries. Many individuals also do not have home computers (relying instead on a computer at work, which they generally use only during business hours on weekdays), or have slow Internet connections.

Third, some information simply is not available from the Internet. For example, some product manufacturers do not have web sites, thereby requiring customers to make direct contact with service representatives via telephone, postal mail, email, and the like. In other instances, manufacturers or other organizations provide information through channels different than the Internet, but potential customers may not be able to easily locate such alternative channels of information.

While the scenario described above is in the context of products and shopping, one can appreciate that there are broader implications associated with individuals' never-ending need for information. For instance, suppose a tourist passing through a town sees a statue in the local park, and wishes to know more about the statue's historical significance. If the tourist has a computer connection back at a hotel room, the user may be able search for information about the statue via the Internet. However, since Internet search engines provide text-based search queries, the user is limited to trial-and-error methods in selecting the proper key words in a query that are most likely to result in a “hit.” It can be very difficult to express in words/text the images that are conveyed by the statue or by any other physical object, thereby resulting in frustration to the user when the search engine returns irrelevant information.

It can also be appreciated that similar problems exist with audio, such as situations where an individual hears a song or a voice, but cannot associated a title and/or person to that audio. Expressing audio in words for purposes of a text query is clumsy at best, and very difficult in many situations.

### BRIEF SUMMARY OF THE INVENTION

One aspect provides a method that includes receiving captured information pertaining to a current user of a device. The captured information is decoded to determine its content, and the determined content is compared with stored content to authenticate the user. If the user is authenticated, the method calls a function having parameters and executes that function to allow the authenticated user to access a service available via the device.

Another aspect provides a method that includes receiving media pertaining to subject matter captured by a device. The received media is decoded to determine its content. The determined content is associated to a function string. The method calls and executes a function identified through the function string to return information to the device that is relevant to the captured subject matter.

### BRIEF DESCRIPTION OF THE SEVERAL VIEWS OF THE DRAWINGS

Non-limiting and non-exhaustive embodiments are described with reference to the following figures, wherein like reference numerals refer to like parts throughout the various views unless otherwise specified.

FIG. 1 depicts various electronic devices with which various embodiments may be implemented.

FIG. 2 illustrates example images or audio that can be captured by the electronic devices of FIG. 1 according to various embodiments.

FIGS. 3A-3B is a flow block diagram of system components and associated operations of an embodiment.

FIG. 4 is a graphical representation of one embodiment of a schema for a storage unit of the system of FIGS. 3A-3B.

FIG. 5 is a diagrammatic representation of a function string according to an embodiment.

FIGS. 6A-6B illustrate an object model according to an embodiment.

FIG. 7 is a flowchart depicting an authentication process according to an embodiment.

FIG. 8 is a flowchart depicting media capture, decoding, a remote function call, and the returning of information according to an embodiment.

### DETAILED DESCRIPTION

Embodiments of techniques that use a server to perform remote function calls to obtain information associated with captured images (as well as audio) are described herein. In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, an embodiment provides a technique to allow relevant information to be returned to users of electronic devices, such as mobile wireless devices. For example, a user with a cellular telephone having a camera can take a picture/image of a car at an automobile dealership lot, and send the image to a server. The server decodes the image to identify the subject matter of the image, and then obtains information relevant to that subject matter (such as manufacturer, model, product reviews, pricing, competitive products, and so forth. This information is returned by the server to the cellular telephone, where the information is displayed for review by the user. It is noted that while a cellular telephone may be used as an example user electronic device, embodiments are provided that can be used in conjunction with any suitable device having the capability to capture images and/or sound.

According to various embodiments, the images captured by the user can be 1D or 2D images. Examples of 1D images include barcodes or other non-human-recognizable images. Examples of 2D images include, but are not limited to, alphanumeric strings, logos, slogans, brand names, serial numbers, text, biometrics (such as fingerprints or facial features), images of various objects (landmarks, animals, inanimate objects, etc.), or virtually any type of human-recognizable image that can be represented in 2D form. In an embodiment, three-dimensional (3D) images (or a semblance thereof can also be captured and represented in 2D form, such as holograms. According to an embodiment, audio can also be captured (including voice recognition implementations, for instance), converted to a file, and sent to the server for processing.

In an embodiment, the server uses at least one of a plurality of plug-in programs to identify the received image. After the image is identified, a function string having a function mask is associated with the identified image. The function string includes an identity of a function to call and the parameters and/or parameter values to be passed to that function. The parameters and parameter values are associated with media information that is to be returned to the user's cellular telephone (for example). Thus, when the function is called and executed, the media information is retrieved, processed, and returned to the user's cellular telephone. The captured images or sounds or other media that may (or may not) specifically identify the particular function to call are sometimes referred to herein as “symbols.”

Various implementation examples will be described below. For instance, embodiments of modules can be used for providing product information, registering software, processing coupons, performing electronic settings, receiving competitive product information, authenticating users, translating foreign language, searching for auctions, biometric processing, and so on. It is appreciated that these are merely examples, and that the invention is not intended to be limited to any particular one or more of the described implementations.

To assist in the identification of received images, one embodiment provides an image pre-processing system. The image pre-processing system applies imaging techniques to extract symbols from poor quality or poor resolution images, thereby increasing the success rate of identification.

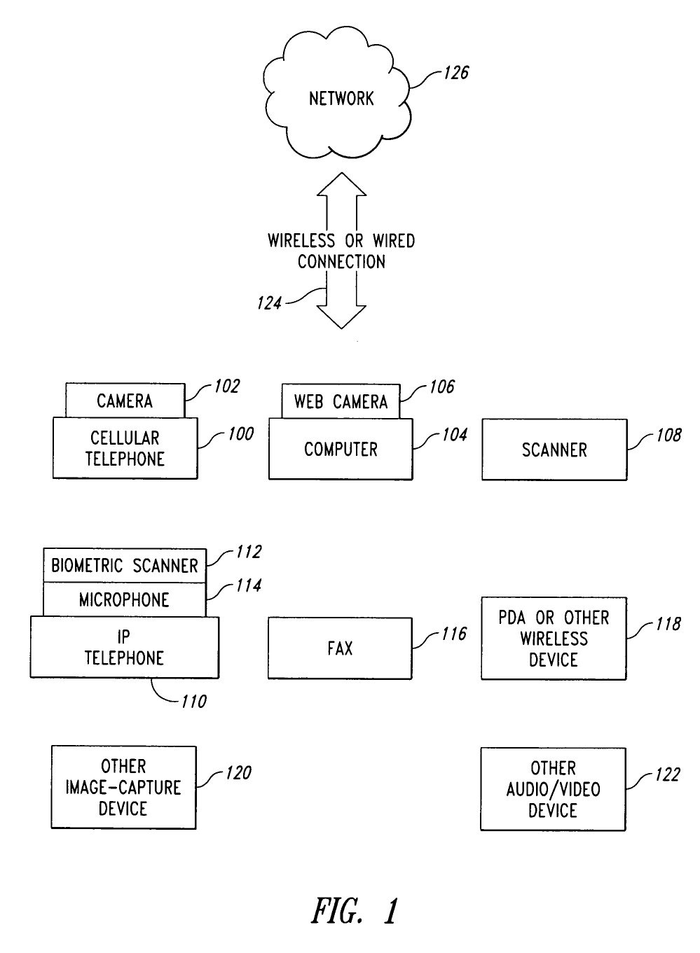

FIG. 1 depicts various electronic devices with which various embodiments may be implemented. It is appreciated that FIG. 1 only depicts some examples of electronic devices that are capable of capturing audio or images (including video), and that other types of electronic devices having the capability to transmit audio or images to a server may also be used by other embodiments. Furthermore, it is understood that the electronic devices of FIG. 1 may have common features in some instances, such as cameras, microphones, network connectivity components, biometric scanners, display screens, web browsers, and so forth. Because the various features of these electronic devices would be known to those skilled in the art having the benefit of this disclosure, such features will not be described in great detail herein.

A cellular telephone 100 includes a camera 102, which allows a user to take photographs or otherwise capture images (including video) by suitably pointing the cellular telephone 100 at a subject of interest. A computer 104, such as a desktop personal computer (PC) or laptop, includes a web camera 106, which allows audio and images to be transmitted over a network (such as the Internet) or saved locally. Other examples include a scanner 108, which can be used to generate electronic images that are originally in hardcopy format.

An Internet Protocol (IP) telephone 110 allows a user to conduct telephone conversations or send facsimiles over an IP telephony network. The IP telephone 110 of one embodiment (as well as any of the other depicted electronic devices) can include a biometric scanner 112 (for capturing fingerprints, facial images, retinal scans, and the like) for purposes of user authentication and a microphone 112.

Other possible example electronic devices include a fax machine 116 and a personal digital assistant 118 or other wireless device. Other image-capture devices 120 and/or audiovideo device 122 may also be used with various embodiments.

The electronic devices of FIG. 1 can communicate, via a wireless and/or wired connection 124, with a network 126. The network 126 can comprise the Internet, a local area network (LAN), virtual LAN, public switched telephone network (PSTN), IP telephony network, satellite communication network, optical network, virtual private network (VPN), other wireless or wired network, or any combination thereof. In an embodiment, a server (explained in more detail below) is provided that can communicate with the electronic devices via the network 126, so as to provide the electronic devices with relevant information pertaining to captured audio or images, authenticate the electronic devices for certain uses, and the like.

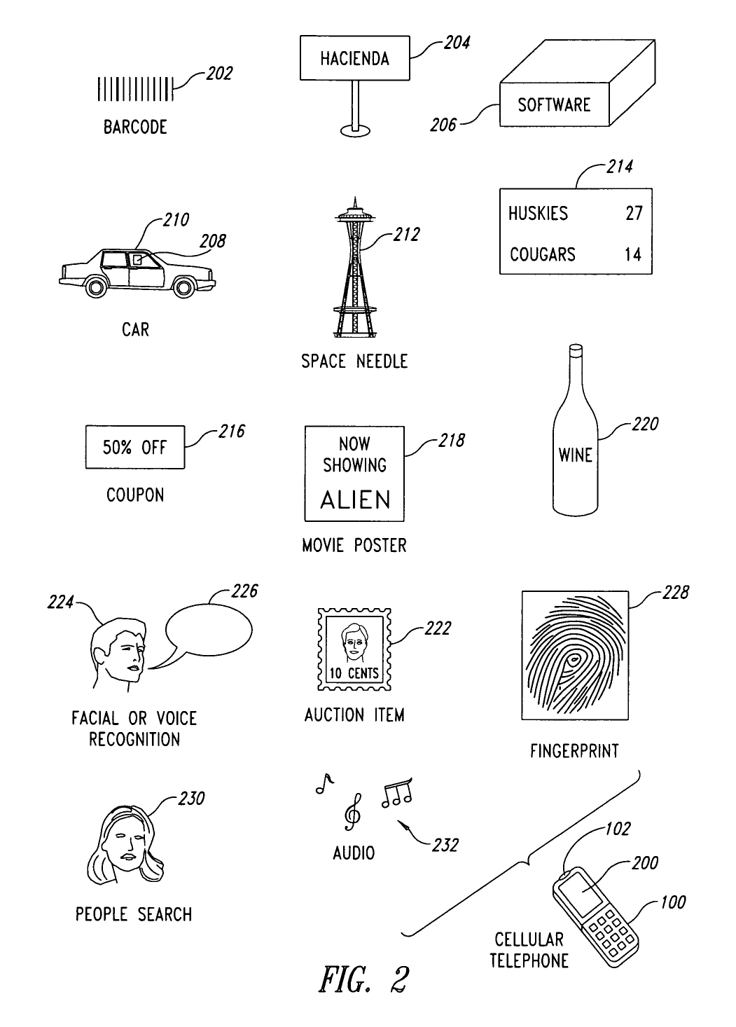

FIG. 2 illustrates example images (of objects) or audio that can be captured by the electronic devices of FIG. 1 according to various embodiments. Again, it is appreciated that FIG. 2 is intended to show only examples and is not intended to be limiting. For purposes of explaining FIG. 2, the cellular telephone 100 will be used as the example electronic device that can capture images or audio (such as via use of the camera 102). The cellular telephone 100 includes a display screen 200 that can be used to allow the user to preview captured images and to view relevant information that may be returned from the server.

An image of a barcode 202 (or other non-human recognizable 1D or 2D image) can be captured by the cellular telephone 100. The barcode 202 can be on product packaging or any other barcoded product. By capturing the image of the barcode 202 and sending the image to the server, pertinent information such as product pricing, product details, related web site uniform resource locator (URL) addresses, or information pertaining to competitive products can be returned to the cellular telephone 100.

An image of a foreign-language object 204 can also be captured and processed. In this example, the foreign-language object is a sign written in Spanish. The server 100 can provide an English-language translation of “Hacienda” or any other foreign-vocabulary word to the cellular telephone 100.

The user may use the cellular telephone 100 to capture an image of a software product 206 (such as its packaging design, barcode, serial number, trademark, product name, or other associated human-recognizable 2D image). By doing this, the user can register the software product 206 (and receive confirmation via the display screen 200 of the cellular telephone), receive product information and pricing, receive information about competitive products, receive product reviews, and so forth.

If the user goes to an automobile dealership and sees a car 208, the user can take a picture of the car 208 (or its window sticker 210), and receive a review of the vehicle. The review or other pertinent information may be received by the cellular telephone 100 as streaming video, graphic or text files, URL links, audio, and the like.

For tourists or other users, an image of a historical site 212 (such as the Space Needle in Seattle, Wash.) can be captured. The user can then receive historical information, admission prices, hours of operation, or other pertinent information generated from the local tourist office, municipality, online literature, and other sources. With any object whose image has been captured (also applicable to captured audio), it is also possible to return Internet engine search results to the cellular telephone 100. For instance, once the server identifies the image of the historical site 212 as being the Space Needle, the server can initiate an image or text search on Google™ or other Internet search engine to obtain a hit list of search results, which can then be conveyed to the cellular telephone 100 for the user's perusal.

If the user is at a college football game, for example, and sees a graphic on a scoreboard 214, the user can take a picture of the scoreboard 214 and send the picture to the server. Once the server derives information from the image (such as the name of a school's team), the server can cause the cellular telephone's 100 ring tone to be the fight song for that school. This is yet one example of the type of information or functionality that can be enabled in response to capturing and processing images and/or audio.

To continue with additional examples, the cellular telephone 100 can be used to scan a coupon 216. The image of the coupon 216 can then be processed by the server to apply discounts for products available at a website or ot otherwise redeem the coupon 216. An image of a compact disk (CD) cover, digital video disk (DVD) cover, or movie poster 218 can be taken, which would then allow the user to receive streaming movie trailers, song samples, ring tones available for purchase, show time schedules, artist information, reviews, locations of theaters or stores, and so forth.

The user can take a picture of an object as simple as a bottle of wine 220. Information the user can receive on the cellular telephone can include suggestions for recommended accompanying foods, price lists from local merchants, winery and vintage information, and others. As another example, the user can take a photograph of collectibles (such as a postage stamp 222), and submit the photograph to the server. The server can then process the photograph to return auction information to the user, such as a listing of postage stamps available for auction on Ebay™ or other auction site.

An embodiment can be used for authentication and security purposes. Users of cellular telephones 100 or IP telephones 110, for example, can be provided with access rights to any telephone on a network by using facial recognition 224 or voice recognition 226. Alternatively or additionally, biometric information, such as a fingerprint image 228 or a retinal image, can be used for authentication.

As a first example, an IP telephony network in a firm may provide connectivity to its employees. However, some employees may have different privileges or access rights than other employees (such as local, long distance, or international calling capabilities). Also, it would be desirable to be able to place an IP telephone call from any telephone or location in the firm, rather than being restricted to making these IP telephone calls just from one's office.

Accordingly, an embodiment allows a user to get authenticated from any telephone and/or location. This authentication can be performed via voice recognition 226, facial recognition 224, fingerprint 228, or other biometric-based authentication using the biometric scanner 112 or other input device on the IP telephone 110. The captured information is sent to the server, which performs an authentication. If authenticated, then the server can initiate completion of connection of the IP telephone call. Different users may be given different levels of authority or privileges.

As a second example, in cases of emergency, federal or state governments, municipalities, the Department of Homeland Security, or other agencies or entities may mandate that some wireless frequencies be set aside for use only by authorized individuals (such as law enforcement, emergency response personnel, city leaders, the military, and the like). It is thus important for such a system that these frequencies be available during emergency situations to authorized personnel, and that hackers or unauthorized users not jeopardize the availability and use of these frequencies.

Accordingly, an embodiment of the backend server authenticates users by comparing biometrics information (such as images of fingerprints or facial features, etc. or voice or that are captured by the user's electronic device) with backend images/audio or other information usable for authentication. Upon authentication of the user, the server will initiate a connection of the user's electronic device to the restricted frequencies.

As another example of FIG. 2, images 230 of oneself or other people (or even animals) can be taken. Then, the images 230 can be sent to the server to, for instance, search for look-alikes of famous people or animals, perform searches for dates with similar looks, perform morphing, and so forth. As another possible application, law enforcement personnel or investigators can discretely capture images of suspects and then have these images compared with backend image files of fugitives or persons with criminal records.

Any type of audio 232 may be captured and identified or otherwise processed by the server. For instance, the user can capture audio or sound bytes of a catchy tune playing on the radio, and have the server return data such as the name of the song, artists, album title, store locations that sell the album, and the like. Many different applications are possible with the capture and processing of the audio 232.

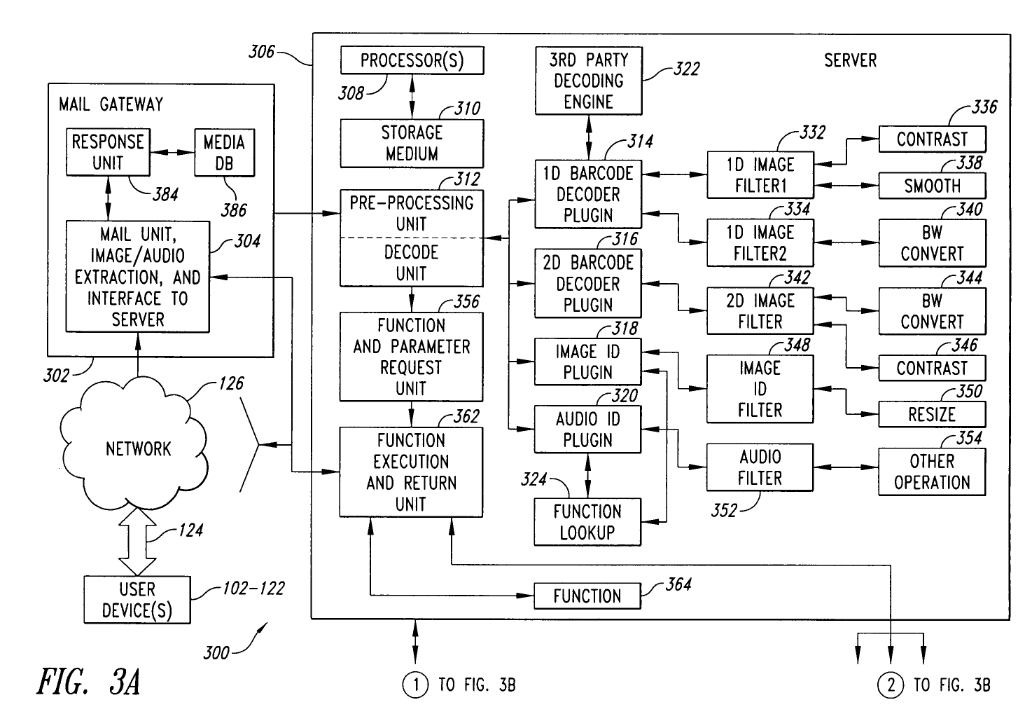

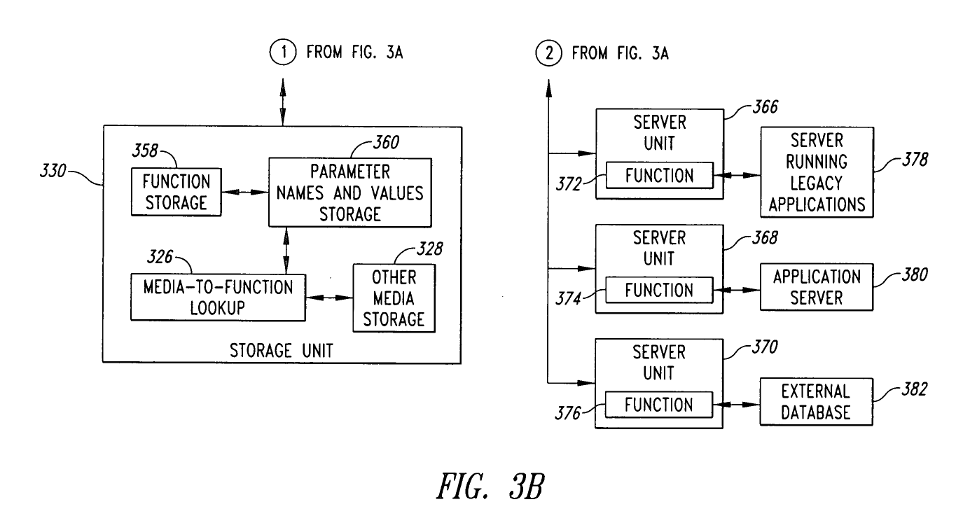

FIGS. 3A-3B is a flow block diagram illustrating components of a system 300 and associated operations of an embodiment. For the sake of simplicity of explanation, only the processes and components that are germane to understanding operation of an embodiment are shown and described herein. In one embodiment, at least some of the processes and components can be implemented in software or other machine-readable instruction stored on a machine-readable medium, and which are executable by one or more processors. The various directional arrows depicted in FIGS. 3A-3B and in other figures are not intended to strictly define the only possible flow of data or instructions-instead such directional arrows are meant to generally illustrate just possible data or process flows, and it is understood that other flows or components can be added, removed, modified, or combined in a manner that is not necessarily the same as depicted in FIGS. 3A-3B (or in the other figures).

A mail gateway 302 is communicatively coupled to the network 126 to receive communication therefrom. More specifically according to one embodiment, the mail gateway 302 can receive emails or other communications sent from one of the user devices 102-122 that has captured images/audio. In the case of email communications, the images or audio can be in the form of one or more attachment files of an email. Possible formats for the images can be JPEG, GIF, MPEG, etc., while audio can be in .mp3, .wav, etc., for example. The mail gateway 302 includes a mail unit 304, which operates to receive the emails, and to strip or otherwise extract the attachments or other information having the captured images and audio. The mail unit 304 also operates to provide an interface with a server 306. For instance, after extracting the attachments from the received emails, the mail unit 304 provides the extracted information to the server 306.

According to one embodiment, the mail gateway 302 runs as a standalone Simple Mail Transfer Protocol (SMTP) server to service decoding requests (e.g., to pass media to the server 306 for decoding). Again, it is appreciated that the mail gateway 302 can operate according to any suitable mail protocol or platform. The mail gateway 302 provides the ability to decode (by the server 306) multiple image attachments per session, wherein all relevant details of incoming messages (such as content in lines, subject fields, attachments, etc. of emails) are automatically parsed and passed to the server 306.

The server 306 includes various software and hardware components for processing, communications, storage, and the like. One or more processors 308 are communicatively coupled to one or more storage media 310. The storage medium 310 can comprise a database, random access memory (RAM), read only memory (ROM), file system, hard disk, optical media, or any other type of suitable storage medium or combination thereof. In an embodiment, the storage medium 310 can store software, objects, static or dynamic code, data, and other machine-readable content with which the processor 308 can cooperate (e.g., execute) to perform the various functionalities described herein. For the sake of explanation, the server 306 of FIG. 3 is shown as having numerous components, which can be implemented in software, that are separated from the storage medium 310—it is appreciated that at least some of these software components may be present in the storage medium 310.

One of these software (or hardware) components is a pre-processing and decoding unit 312. The unit 312 operates to receive the extracted media (such as image or audio files) from the mail unit 304, pre-process the received media (if needed) to improve its quality and/or to place the media in a suitable format for decoding, and to decode the received media to identify information therefrom.

With regards to decoding, the unit 312 of one embodiment uses a plurality of decoder plug-in programs 314-320 (or other suitable decoder modules). The plug-in program 314 is used for decoding 1D barcodes; the plug-in program 316 is used for decoding 2D barcodes; the plug-in program 318 is used for decoding or otherwise identifying (ID) images (including video frames); and the plug-in program 320 is used for decoding audio. There may be more or fewer plug-in programs than what is explicitly shown in FIG. 3A. In one embodiment, the plug-in programs can comprise any suitable commercially available media decoder programs for images, audio, or other media.

In one embodiment, the unit 312 iteratively sends each received media file (such as an image or audio file) to each plug-in program 314-320, until one of these plug-in programs is able to successfully decode and identify the content of the media file (e.g., able to identify a serial number, an object in an image, a person's voice in an audio file, etc.), and returns the result to the unit 312. In another embodiment, the unit 312 can be programmed to specifically direct the received media file to only one (or just a few) of the plug-in programs 314-320, rather than iteratively sending the received media file to each of them. In the case of a successful decoding of a 1D or 2D barcode or other data-carrying image, the plug-in programs 314 or 316 return the alphanumeric text or other data carried by that image. One or more third-party decoding engines 322 may be used by the plug-in programs 314 or 316 to assist in decoding or otherwise interpreting the 1D or 2D barcodes to obtain the data carried thereon.

For images or audio that may not necessarily carry data, the plug-in programs 318 or 320, respectively, can access a function lookup module 324 to assist in identifying the image/audio and the associated function string(s). For example, if the received image is that of the historical site 212 of FIG. 2, then the function lookup module accesses either or both a media-to-function lookup unit 326 (to determine which function string is associated with the historical site 212) or a media storage location 328 (to identify the historical site 212 as the Space Needle) of FIG. 3B. Fuzzy logic or checksums may be used if needed to locate a match.

The media-to-function lookup unit 326 and/or the media storage location 328 may be present in the server 326 or in an external storage unit 330. In an embodiment, the media-to-function lookup unit 326 comprises a lookup table or database that lists the functions (or function strings, explained later below) associated with identified content of media, wherein the media content may be identified by accessing the media storage location 328. The media storage location 328 can be a database, lookup table, file system, or other suitable data structure that can store file images, audio, fingerprints, voice clips, text, graphics, or virtually any type of information that can be correlated or compared to received media content for purposes of identifying that received media content for the plug-in programs 318-320 or other plug-in programs.

According to one embodiment, the received media may be formatted or “cleaned-up” prior to being decoded, so as to increase the likelihood of a successful decode. In the context of the 2D barcode decoder plug-in 316, for instance, that plug-in program may require that the image to decode be in 8-bit bitmap format. Thus, an embodiment provides media pre-processing capability, prior to decoding, in the form of operation sets that operate as media filters to place the received image in either a proper format and/or to improve image/audio quality prior to decoding (e.g., sharpen grainy or blurred images or audio).

In the example of FIG. 3A, the 1D barcode decoder plug-in program 314 has two operation sets (1D image filters 332 and 334). The filter 332 performs contrast adjustment 336 and smoothing 338. The filter 334 performs black and white (BW) conversion 340. In an embodiment, not all operation sets need to be applied prior to decoding. For example, if application of the first operation set (filter 332) results in a successful decode, then the second operation set (filter 334) does not need to be applied, or vice versa. However, if application of the initial operation set(s) do not result in a successful decode, then additional operation set(s) can be applied until a successful result is attained.

Other examples of operation sets in FIG. 3A include a 2D image filter 342 that can perform either or both BW conversion 344 and contrast adjustment 346 operations. An image identification (ID) filter can perform a resizing 350 operation or other operations, while an audio filter 352 can perform other operations 354 to improve or change audio quality and format. It is appreciated that the various operations depicted in FIG. 3A are merely illustrative and not intended to be exhaustive or restrictive for any one of the plug-in programs 314-320.

With a successful decode, the plug-in programs 314-320 generate or return function strings as results. With 1D and 2D barcodes (or other data carrying images), the returned results are generally strings of alphanumeric characters. With other images and audio, the returned results can also be alphanumeric function strings, as obtained from the media-to-function lookup unit 326. As will be described later below, the function strings are associated with a function mask and specify the function, its parameters, and values of the parameters.

The function strings are provided by the pre-processing and decode unit 312 to a function and parameter request unit 356. The request unit 356 parses the function string to obtain an ID of the specified function, obtains the parameter(s) for that function, and the values of the parameter(s) from the storage unit 330 of FIG. 3B. The storage unit 330 of one embodiment includes a function storage location 358 that stores function names and the functions themselves (such as formulas, code, scripts, logical relationships, objects, and so forth). The storage unit 330 also includes a parameter names and values storage location 360. This storage location 360 stores parameter names, associated values, and other information usable as arguments or other data used by the corresponding functions.

Once the functions, parameters, and parameter values are called or otherwise obtained by the request unit 356, a function execution and return unit 362 executes the specified function and returns the result to the corresponding user device 102-122. In one embodiment, the functions can be executed at the server 306, by implementing business logic to be executed or other intelligence. These functions executed at the server 306 are shown at 364 in FIG. 3A.

Alternatively or additionally, the functions may be called and/or executed remotely. For instance and with reference to FIG. 3B, a plurality of server units 366-370 can be communicatively and remotely coupled from the server 306. These server units 366-370 can host (and execute) respective functions 372-376. Each of the functions 372-376 can in turn cooperate with other network components to obtain parameters, parameter values, and other data usable during execution. As examples, the function 372 can obtain data from a third-party server 378 running legacy applications; the function 374 can obtain data from an application server 380; and the function 376 can obtain data from an external database 382 or other source.

In one embodiment, the function execution and return unit 362 can return the responsive information directly to the originating user device 102-122, such as by way of the network 126 and without having to route the responsive information to the mail gateway 302. Alternatively or additionally, the function execution and return unit 362 can send the responsive information to the mail gateway 302, to be received by the mail unit 304. The mail unit 304 can then direct the responsive information to the originating user device 102-122, or route the responsive information to a response unit 384 of the mail gateway 302.

In one embodiment, the response unit 384 uses the responsive information received from the server 306 to look up and form a response to the user device. For example, the responsive information received from the server 306, as a result of execution of the corresponding function, may instruct that a message and URL be generated and sent to the user device. The response unit 384 performs this operation by obtaining the message and/or URL (or other media or data) from a media database 386 of the mail gateway 302, generating a response therefrom in a suitable response format, and providing the generated response to the mail unit 304 for transmission to the originating user device 102-122.

Of course, it is to be appreciated that in other embodiments, elements of the server 306 itself may perform this response generation and media lookup, thereby eliminating or reducing the need for a separate components (e.g., the response unit 384 and the media database 386) at the mail gateway 302 to perform such operations. In yet other embodiments, either or both the response unit 384 and the media database 386 may themselves be located at the server 306.

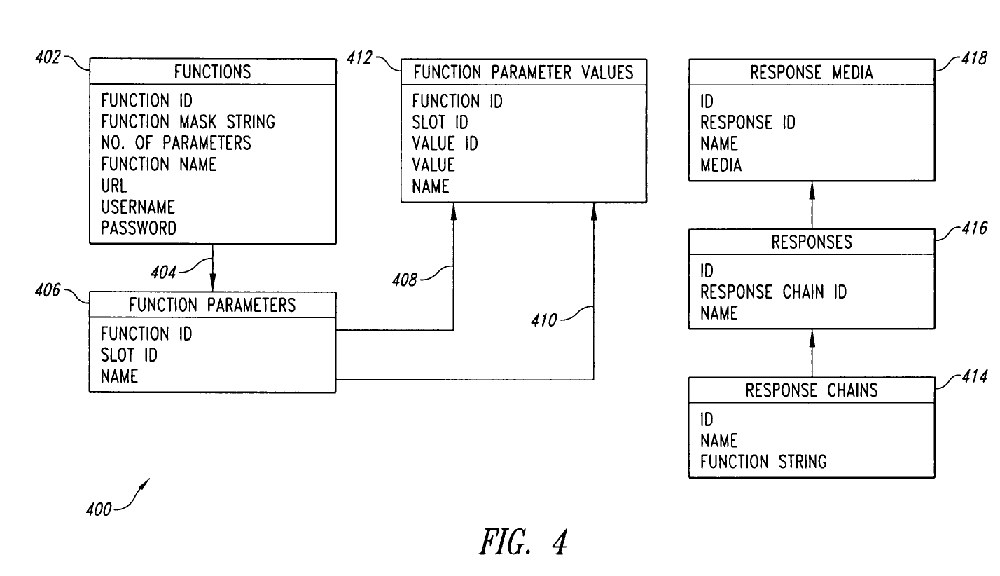

FIG. 4 is a graphical representation of one embodiment of a schema 400 for the storage unit 330 of FIG. 3B, such as for example, if the storage unit 330 is implemented in database format. It is appreciated that the schema and its contents are merely for illustrative purposes, and that other schemas, data structures, or data relationships may be used.

A functions table 402 contains entries associated with functions. These entries can include, but are not limited to, function ID, function mask string, number of parameters, function name, URL, username, and password. The function ID is an alphanumeric code that uniquely identifies each function. The function mask string specifies the length of each function string (explained later below). Each function can have any number of parameters (or arguments) specified, as well as a function name. URL, username, and password are entries that define where the function is called on a particular server unit 366-370 (or the server 306) and other criteria.

The entries in the functions table 402 are linked (depicted at 404) to a functions parameters table 406. The functions parameters table 406 contains entries associated with parameters for each function. For example, for each function ID, there are slot IDs (e.g., a slot in the function string) that are associated to respective parameter names that are to be used by that function.

The entries in the function parameters table 406 are linked (depicted at 408 and 410) to a function parameter value table 412. For example, the link 408 links the corresponding function to the function parameters table 406, while the link 410 links the parameters of that function (or more particularly, the slot ID where the parameters are specified) to the value entries for the parameters in the function parameters table 412. The function parameters table 412 can have fields that contain the function ID, slot ID, value ID (i.e., the ID of the value assigned to each parameter), value, and value name.

Tables 414-418 relate to response chains, responses, and response media. For example, if a particular response is to be sent from the server 306 (alternatively or in addition to having such responses assembled at the mail gateway 302), the tables 414-418 can be used to correlate the specific function strings to specific response content. With regards to the media-to-function lookup unit 326 and the media storage location 328, the tables 414-418 can be used to index specific pieces of media and to correlate these pieces of media to specific functions. Each piece of media, response, and response chain can have their own associated name and ID.

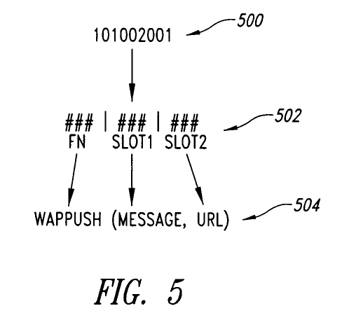

FIG. 5 is a diagrammatic representation of a function string according to an embodiment. An example function string is shown at 500. This embodiment of the function string 500 comprises a series of nine numerical characters 101002001, and it is to be appreciated that the function string 500 can be of any suitable length, character format (numerical, alphabetical, binary, etc.), content, and so forth. The characters 101002001 may be carried in and extracted from a barcode, or correlated with an identified image (via use of the media-to-function lookup unit 326), for example.

The function string 500 is associated with a function mask 502. The function mask 502 operates to define a format of the function string and the manner in which the function string is to be parsed to identify the corresponding function and its parameters. In this example, the function mask 502 comprises a series of # symbols separated by pipe symbols |. The pipe symbols | break up the function string into groups of three # symbols, wherein the first three # symbols define a function number, the second three # symbols are associated with slot 1, the third three # symbols are associated with slot 2, and so forth. Each # symbol represents a number from 0-9, and therefore, each group of three # symbols can represent a number between 000-999. It is appreciated that the number of total # symbols in the function mask 502 can be of any suitable fixed or dynamic length, and that the pipe symbols | need not necessarily break up the function string into just groups of three # symbols.

In this example, the first 3 numbers in the function string 500 are the numbers 101, which corresponds to some function identified in the function storage location with the number 101. For purposes of this example, function 101 is a function named WAPPUSH, which relates to a function that provides/pushes information to a wireless user device using the Wireless Application Protocol (WAP). The next 3 numbers in the slot 1 of the function string 500 are 002, which corresponds to some parameter found in the storage location 360. In this example, the name of that parameter corresponding to 002 is MESSAGE. Since the function string 500 has 3 remaining numbers (001), this means that there is another parameter that can be passed to the function 101. In this example, this additional parameter is named URL, which is identified by the 001 entry in the storage location 360.

Thus, the function corresponding to the string 500 is WAPPUSH(MESSAGE, URL). In an example implementation, after capturing and sending an image and after the function executes, the user would receive a MESSAGE on his cellular telephone 100 (such as “Do you wish to view a competitive product? If so, click here.”), along with a link that provides a URL to the competitive product information. The MESSAGE “Do you wish to view a competitive product? If so, click here.” and the specific URL that provides the link are values of the two parameters passed to the function 101, and which may be stored in and obtained from the storage location 360.

While the example of FIG. 5 describes an implementation where the function string 500 is broken up according to function ID and then parameter IDs in each subsequent slot, it is appreciated that other data organization techniques may be used. For example, some of the slots may specify the number of parameters to use, the number of values corresponding to each parameter, value ID numbers, or even the parameter names, value names, or values themselves or combinations thereof. There may be multiple function masks associated with each image or audio piece, including the nesting of function masks (of possibly different lengths) at different levels.

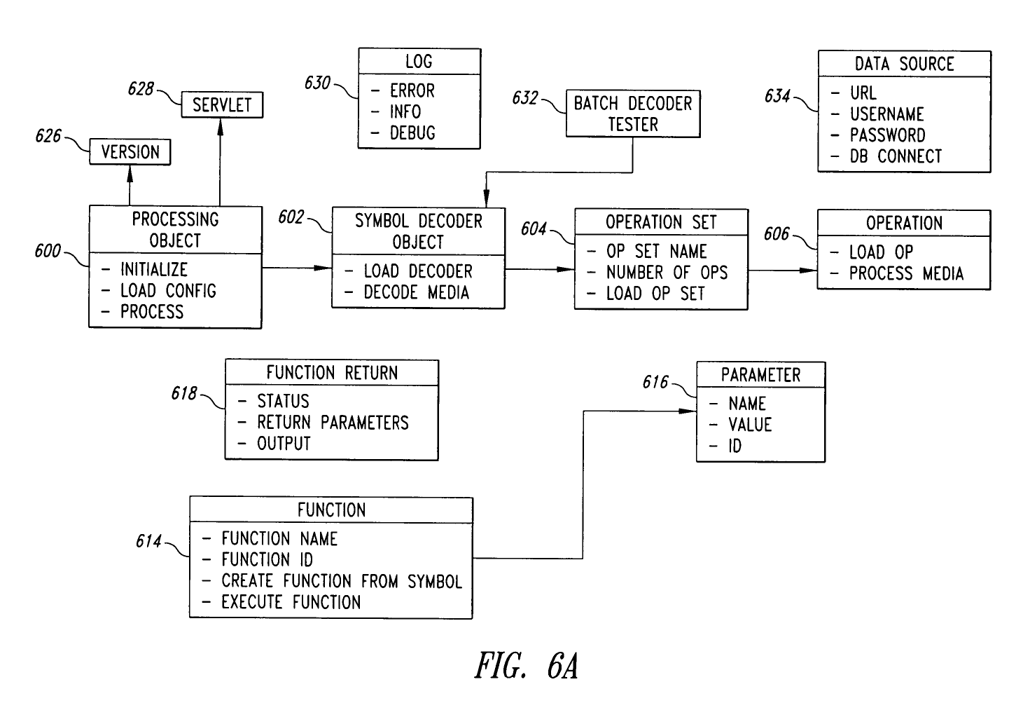

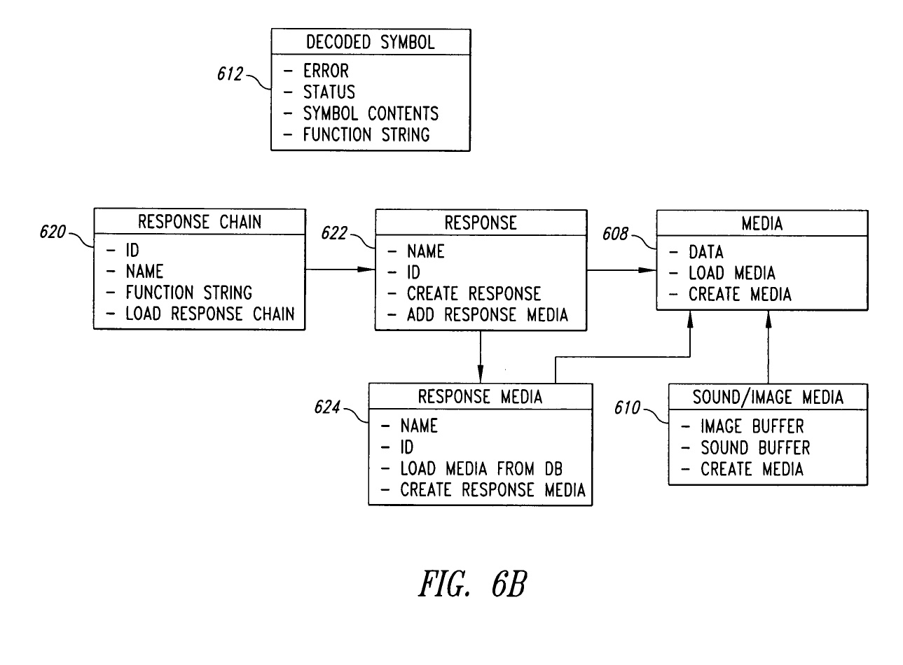

FIGS. 6A-6B illustrate an overall object model according to one embodiment. Elements of the object model may be implemented in software, code, modules, or other machine-readable instructions stored on a machine-readable medium. For instance, the object model of FIGS. 6A-6B can represent software stored in the storage medium 310 and/or storage unit 330, and which is executable by the processor 308. At least some of the elements or operations in FIGS. 6A-6B (or portions thereof can coincide with the elements or operations depicted in FIGS. 3A-3B.

A main or central processing object 600 operates as the main function that the server 306 calls into to initialize the decoding process, to load configuration data, or to perform other processes associated with decoding media and returning responses to the user device. With regards to the initialization process, the processing object 600 loads configuration information and calls a symbol decoder object 602.

The symbol decoder object 602 loads each of the decoder plug-in programs 314-320 into memory. Then, each decoder plug-in program 314-320 loads its configured operation sets (e.g., the media filters 332-352). The operation sets can comprise one or more objects 604 that specify the operation set name, the number of operations, and the like. The object 604 then populates the operation sets by loading operations 606 into memory.

When the server 306 receives an image or other media file to decode, an embodiment loads the media file into a media object 608, which operates as a type of “wrapper” for the media file. Received sound or image media may also be stored objects 610 in buffers. Alternatively or additionally to media files that are to be decoded, the objects 608 and 610 can also represent media or other information that is to be packaged in a response to the user device.

The media file to decode is then passed to the symbol decoder object 602, which calls a “decode media” function/operation that runs the decoder plug-in programs' 314-320 loaded operation set(s) on the media file. That is, the operations set(s) process the media to “clean it up” or place the media in proper format, and then this media is decoded. If necessary, third-party decoders may also be called by the decode media function to identify the received media.

If a successful decoding results, then the processing object 600 creates a decoded symbol object 612. The decoded symbol object 612 carries data back to the processing object 600, indicating the contents of the symbol (e.g., identification of the content of an image or audio), the function string (such as if a function string is directly obtained from a decoded barcode), status information, or an error message (such as if decoding did not succeed in identifying the media).

Next, the processing object 600 calls a “create function from symbol” method in a function object 614. When this method executes, the identified symbol is used to request the corresponding function string, which is associated with a function name, function ID, and parameter names, values, and IDs from a parameter object 616.

The processing object 600 next calls an “execute function” method in the function object 614 to call and execute the function. A function return object 618 provides status information as to whether the function was successfully called and executed, and returns the output of the executed function to the mail gateway 302 (or other unit responsible for sending the output to the user device).

FIG. 6B shows other objects used by an embodiment. For instance, there may be a response chain object 620, a response object 622, and a response media object 624. These objects 620-624 operate to format and package a response based on the executed function and the availability of response media to send to the user device.

Other example objects, at least some of which may be optional, are depicted in FIG. 6A. A version object 626 is indicative of the software version being used by the server 306. A servlet (such as a FloodServlet) 628 operates in conjunction with the processing object 600. A log object 630 is used to log errors or other information for debugging purposes (or other uses). A batch decoder object 632 can be used to test the symbol decoder object 602 by providing a batch of images to decode. A data source object 634 is used in conjunction with operations involving database connection and access.

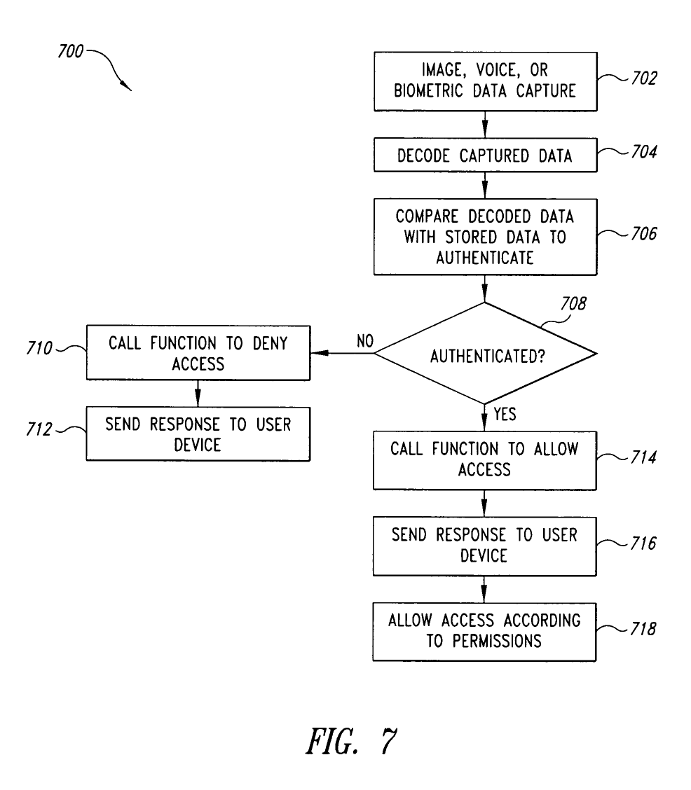

FIG. 7 is a flowchart 700 depicting an authentication process according to an embodiment, and which is based at least in part on the principles described with respect to the previous figures. At a block 702, an image, voice, or other biometric feature of the user (such as a cellular telephone or IP telephone user) is captured and sent to the server 306. As an example, the user is trying to get authenticated or authorized to use certain cellular telephone frequencies during an emergency situation, or to use someone else's IP telephone to make a long distance telephone call.

At a block 704, the server 306 receives the captured data, performs pre-processing if appropriate, and attempts to decode the captured data. More specifically in this example, the server 306 attempts to identify the nature of the content of the data (e.g., determine that there is a face in the image, voice in the audio, fingerprint in the image, etc.). These operations are performed using an appropriate one of the plug-in programs 318 and/or 320, and filters 348-352.

Upon identification that the data contains a face, voice, fingerprint, etc., the server 306 at a block 706 compares the decoded data with stored data to authenticate the user (e.g., to determine if the identified image, voice, or biometric belonging to the user corresponds to persons who are authorized). This operation may be performed, for example, by having the plug-in programs 318 and/or 320 compare the decoded data with stored reference data in the media storage location 328 in FIG. 6B.

If there is no match, meaning that the user is not authenticated as an authorized user, then a corresponding function is called at a block 710 to deny access to the user. When this function is called, its parameters and parameter values passed, and then executed, a response is packaged and sent to the user at a block 712. The response may be a displayed message (provided through a parameter value), for example, that says “Sorry. You are not allowed to use this device at this time.”

However, if the user is authenticated at the block 708, then a function is called at a block 714 to allow access to the user. When this function is called, its parameters and parameter values passed, and then executed, a response is packaged and sent to the user at a block 716. The response may be a displayed message, such as “You are authenticated. Press any key to continue.” To allow access, the server 718 executes that same function or another function to initiate the appropriate network (e.g., cellular network or IP telephony network) to open a frequency for the user's device.

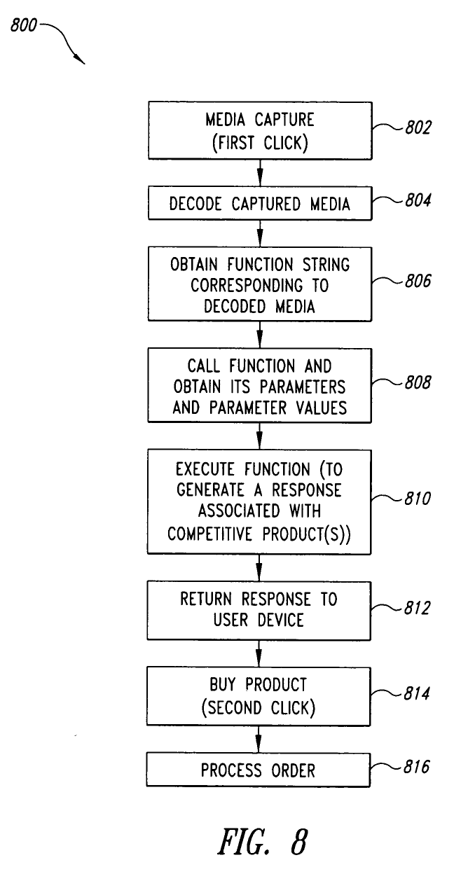

FIG. 8 is a flowchart 800 depicting media capture, decoding the decoded media, a remote function call, and the returning of information according to an embodiment, and which is also based in part with respect to at least some of the figures described above. The flowchart 800 represents, as one example, operations that may be associated with purchase of a product using a “two-click” approach.

At a block 802, some type of media is captured by the user device, such as an image of a product at a store. This may involve having the user perform a “first click” of a button on the cellular telephone 100 (or other first user action) to take a picture of the product, and initiate the transmission of the resulting image to the mail gateway 302.

At blocks 804-806, the captured image is sent to the server 306, pre-processed, and decoded to obtain a function string corresponding to the captured image. In this particular example, the function string that may have been configured for this type of image can be a function string related to providing “competitive product” information (as compared to information about the specific product associated with the captured image).

At a block 808, the function specified in the function string is called, including obtaining its parameters and parameter values. The parameter values can include items such as URL links to competitor web sites, images of competing products, one or more messages that say, “Do you wish to see other similar products? Yes/No,” and other information.

When the function is executed at a block 810, a response associated with the competitive product(s) is generated. This function may be executed at the server 306 to generate the response, or executed at the remote server units 366-370. Alternatively or additionally, the response may be generated at the mail gateway 302. The generated response is returned to the user's device at a block 812.

The response that is generated and returned to the user's device can include competitive product information, images of competitive products, links to informational web sites, and so forth. At a block 814, the user can purchase the product pertaining to the original image that was sent to the mail gateway 302 or one of the competitive products that was returned in the response. According to an embodiment of the two-click purchase method, the user can perform a second click (or other user action) at the block 814 to purchase the product(s).

Information associated with this second click is sent to the mail gateway 302 or to some other network location that processes online orders. The order is processed at a block 816, which can include activities such as sending order forms to the user to complete, providing selection menus to the user, or other activities associated with completing the user's order.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

For example, the mail gateway 302 and server 306 are shown in FIG. 3A as separate components. It is appreciated that in an embodiment, a single component can be used to provide the same functionality. For instance, email reception, image/audio extraction, response generation, and other operations can be performed in whole or in part by the server 306. Similarly, some decoding may also be performed by the mail gateway 302, instead of being exclusively performed by the server 306.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method, comprising:
receiving captured information pertaining to a current user of a device;
decoding the captured information to determine its content;
comparing the determined content with stored content to authenticate the user; and
if the user is authenticated, calling a function having parameters and executing that function to allow the authenticated user to access a service available via the device.

2. The method of claim 1 wherein executing the function to allow the authenticated user to access the service includes executing the function to allow the authenticated user to access an IP telephony service.

3. The method of claim 1 wherein executing the function to allow the authenticated user to access the service includes executing the function to allow the authenticated user to access a restricted wireless channel.

4. The method of claim 1, further comprising associating the determined content with a function string that specifies the function and at least one parameter to pass to the function.

5. The method of claim 1 wherein calling and executing the function includes remotely calling and executing the function.

6. The method of claim 1 wherein receiving the captured information includes receiving at least one of an image, audio, and biometric data associated with the current user of the device.

7. The method of claim 1, further comprising calling another function that denies access and sending a corresponding response message to the device if the user is not authenticated.

8. The method of claim 1, further comprising pre-processing the received captured information prior to decoding to at least one of improve a quality of that information and change a format of that information.

9. The method of claim 1 wherein decoding the captured information includes using a plurality of different decoders to attempt to decode the captured information, until at least one of these decoders results in a successful decoding.

10. A method, comprising:
receiving media pertaining to subject matter captured by a device;
decoding the received media to determine its content;
associating the determined content to a function string; and
calling and executing a function identified through the function string to return information to the device that is relevant to the captured subject matter.

11. The method of claim 10 wherein receiving the media includes receiving at least one of a human-recognizable image of the subject matter, audio associated with the subject matter, biometric information, and non-human-recognizable image.

12. The method of claim 11 wherein receiving the non-human-recognizable image includes receiving at least one of a 1D and 2D barcode.

13. The method of claim 10 wherein decoding the received media includes iteratively attempting to decode the media through a plurality of different decoders until at least one of these decoders results in a successful decoding.

14. The method of claim 10, further comprising pre-processing the received media prior to decoding.

15. The method of claim 10 wherein associating the determined content to the function string includes associating the determined content to a function mask that defines portions of the function string that identify the function and at least one of its parameters.

16. The method of claim 10 wherein associating the determined content to the function string includes associating the determined content to an alphanumeric string that provides an ID of the function and parameter data pertaining to that function.

17. The method of claim 10 wherein calling the function includes calling the function from a server unit remote from a server that receives the captured media.

18. The method of claim 10 wherein executing the function includes providing access to a restricted service to an authenticated user of the device.

19. The method of claim 10 wherein returning information to the device that is relevant to the captured subject matter includes at least one of returning data pertaining to a captured barcode, translation of a foreign language term, software registration information, product information, historical data, electronic device settings, coupon redemption, movie information, competitive product data, menu suggestions, acknowledgement of facial or voice recognition, auction listings, biometric authentication information, people search data, and audio data.

20. The method of claim 10 wherein receiving the media includes receiving the media as part of an email, the method further comprising extracting the media from the email and passing the extracted media to at least one decoder.

21. An article of manufacture, comprising:
a machine-readable medium having instructions stored thereon to:
pre-process captured information pertaining to a current user of a device;
decode the captured information to determine its content;
compare the determined content with stored content to authenticate the user; and
call a function, if the user is authenticated, having parameters that specify values pertaining to permissions of the authenticated user and execute that function to allow the authenticated user to access a service available via the device.

22. The article of manufacture of claim 21 wherein the instructions to pre-process the captured information includes instructions to pre-process at least one of voice, image, and biometric data provided by the current user.

23. The article of manufacture of claim 21 wherein the instructions to execute the function includes instructions to allow the authenticated user to access at least one of a restricted wireless frequency and an IP telephony service.

24. The article of manufacture of claim 21 wherein the instructions to decode the captured information include instructions to iteratively attempt to decode the captured information with a plurality of different decoders until one of these decoders provide a successful decode.

25. The article of manufacture of claim 21 wherein the machine-readable medium further includes instructions stored thereon to associate the determined content with a function string, represented by a function mask, that specifies the function and the parameters to pass to that function.

26. A system, comprising:
a means for receiving media pertaining to subject matter captured by a device;
a means for decoding the received media to determine its content;
a means for associating the determined content to a function string; and
a means for calling and executing a function identified through the function string to return information to the device that is relevant to the captured subject matter.

27. The system of claim 26 wherein the means for decoding the received media include means for decoding human-recognizable or non-human-recognizable media.

28. The system of claim 26, further comprising a means for extracting the received media from a communication received from the device, and a means for generating a response having the relevant information.

29. The system of claim 26, further comprising a means for authenticating a user of the device.

30. The system of claim 26, further comprising a means for capturing the subject matter and for sending the captured subject matter to be decoded.

31. The system of claim 26, further comprising a means for defining a function string associated with the function and its parameters.

32. The system of claim 26, further comprising a means for storing information pertaining to functions, reference data, and media to be returned to the device.

33. The system of claim 26, further comprising:
a means for processing a first user action associated with capturing the subject matter; and
a means for processing a second user action associated with purchasing a product related to the captured subject matter.

34. An apparatus, comprising:
a first unit to receive captured media;
at least one second unit coupled to the first unit to decode the captured media;
a third unit coupled to the second unit to request a function and its parameters corresponding to the decoded media; and
a fourth unit coupled to the third unit to execute the requested function and to return a result of the executed function that is related to the captured media.

35. The apparatus of claim 34, further comprising at least one fifth unit coupled to the at least one second unit to pre-process the captured media prior to decode.

36. The apparatus of claim 35 wherein the at least one fifth unit comprises a plurality of filters having operation sets that apply operations to the captured media to improve its quality or to change its format.

37. The apparatus of claim 34 wherein the at least one second unit includes a plurality of different decoders usable for different media types.

38. The apparatus of claim 34, further comprising another unit to associate a function string with the decoded media.

39. The apparatus of claim 34, further comprising at least one processor and a storage medium, wherein at least some of the units are embodied in software stored on the storage medium and executable by the processor.

40. The apparatus of claim 34, further comprising a storage unit to store function information, parameters and parameter values, and media.

41. The apparatus of claim 40 wherein the storage unit includes a media-to-function lookup unit to associate the decoded media to a function.

42. The apparatus of claim 34, further comprising at least another unit on which the function is executed.

43. The apparatus of claim 42 wherein the at least another unit is remotely located from at least some of the other units.

44. The apparatus of claim 34, further comprising a mail unit to extract the captured media from a communication received from a user device, and to provide the captured media to the first unit.

45. The apparatus of claim 44, further comprising a response unit to package the result of the executed function as a response to the user device.

46. The apparatus of claim 45 wherein either one or both of the mail unit and response unit are located in a mail gateway device remote from the other units.

47. The apparatus of claim 34 wherein one of the second units includes a user authentication unit.

48. The apparatus of claim 34 wherein the second unit comprises a decoder plug-in program.

49. The apparatus of claim 34 wherein at least some elements of the units are embodied as objects.
